(19) United States
(12) Patent Application Publication
(10) Pub. No.: US 2013/0138832 A1
(43) Pub. Date: May 30, 2013

(54) METHOD, ROUTER BRIDGE, AND SYSTEM FOR TRILL NETWORK PROTECTION

(71) Applicant: Huawei Technologies Co., Ltd., Shenzhen (CN)

(72) Inventors: Hao QI, Nanjing (CN); Ying XIE, Nanjing (CN); Yan ZHANG, Nanjing (CN); Guangrui WU, Nanjing (CN); Yinwei LUO, Shenzhen (CN)

(73) Assignee: Huawei Technologies Co., Ltd., Shenzhen (CN)

(21) Appl. No.: 13/683,076

(22) Filed: Nov. 21, 2012

(30) Foreign Application Priority Data
Nov. 23, 2011 (CN) 201110375693.9

(51) Int. Cl. H04L 12/56

(52) U.S. Cl. CPC H04L 45/026
USPC 709/238

(57) ABSTRACT

Embodiments of the present invention disclose a method, a router bridge, and a system for TRILL network protection. An active RB node and a standby RB node share a virtual Nickname and a virtual MAC address, and construct a protection group. The active RB node, through the TRILL protocol, obtains a network topology and generates a forwarding path to perform forwarding of a data packet. When the active RB node is faulty, the standby RB node is raised to be active and the data packet is forwarded through the standby RB node, so that the time for fault recovery is shortened, thereby solving the problem that in an existing TRILL network when a root RB node is faulty, a long time for the fault recovery causes a service interruption and affects network performance.

### CROSS-REFERENCE TO RELATED APPLICATION

This application claims priority to Chinese Patent Application No. 201110375693.9, filed on Nov. 23, 2011, which is hereby incorporated by reference in its entirety.

### FIELD

The present invention relates to the field of network communications, and in particular, to a method, a router bridge, and a system for TRILL network protection.

### BACKGROUND

A switch in a transparent interconnection of lots of links (Transparent Interconnection of Lots of Links, abbreviated as TRILL) network has a layer-2 forwarding function and a layer-3 routing function at the same time, and is usually referred to as a router bridge (Router Bridge or RBridges, abbreviated as RB). The TRILL runs over a data link layer (Data Link Layer), namely layer-2 of an open system interconnection (Open System Interconnection, abbreviated as OSI) reference model, and applies a link state routing technology to the data link layer without interfering with the work of an upper layer router.

In the TRILL network, the RB runs an intermediate system to intermediate system (Intermediate system to intermediate system, IS-IS) protocol to broadcast connection information to all RBs, and therefore each RB can learn about other RBs in the network and connection relationships among the RBs. The RB has sufficient information to calculate an optimal path of unicast to any network node, and may calculate a multicast distribution tree for unicast, multicast, or broadcast with an unknown destination address.

The RB in the TRILL network calculates the multicast distribution tree according to a same root RB. If the root RB of the multicast distribution tree is faulty, all nodes in the network need to recalculate a multicast distribution tree according to a new root RB, where the amount of calculation is relatively large and the time for fault recovery is long, thereby causing a service interruption, and affecting the performance of the TRILL network.

### SUMMARY

Embodiments of the present invention provide a method, a router bridge, and a system for TRILL network protection, so as to solve the problem that when a root RB node in an TRILL network is faulty, a long time for fault recovery causes a service interruption and affects network performance.

In one aspect, the present invention provides a method for Transparent Interconnection of Lots of Links TRILL network protection, includes:
negotiating, by a first router bridge RB, with a second RB about an active/standby state, where the first RB and the second RB have the same virtual nickname Nickname and virtual media access control MAC address;
when the state of the first RB is active, establishing, by the first RB, a neighbor relationship with another RB other than the second RB through a Hello message according to the virtual MAC address, obtaining network topology information according to the virtual Nickname, and generating and delivering a neighbor check table, a reverse path forwarding RPF table, and a TRILL forwarding table; and
when the state of the first RB is standby, if the second RB is faulty, raising the state of the first RB from standby to active, and notifying another RB in the network of the fault of the second RB so that another RB updates the network topology information, the neighbor check table, the reverse path forwarding RPF table, and the TRILL forwarding table; and generating and delivering, by the first RB, a neighbor check table, a reverse path forwarding RPF table, and a TRILL forwarding table.

In another aspect, the present invention provides a router bridge RB in a transparent interconnection of lots of links TRILL network. The RB includes an active/standby negotiating module, a neighbor establishing module, a topology obtaining module, an entry generating and delivering module, and a fault notifying module, where
the active/standby negotiating module is configured to negotiate with a second RB about an active/standby relationship, where the RB and the second RB have the same virtual nickname Nickname and virtual media access control MAC address;
the neighbor establishing module is configured to, when the state of the RB is active, establish a neighbor relationship with another RB other than the second RB through a Hello message according to the virtual MAC address;
the topology obtaining module is configured to, when the state of the RB is active, obtain network topology information according to the virtual Nickname;
the entry generating and delivering module is configured to generate and deliver a neighbor check table, a reverse path forwarding RPF table, and a TRILL forwarding table; and
the fault notifying module is configured to, when the state of the RB is standby and the second RB is faulty, update the state of the RB to be active and notify another RB in the network of the fault of the active node.

In another aspect, the present invention provides a system for transparent interconnection of lots of links TRILL network protection, where the system includes a first router bridge RB and a second RB. The first RB and the second RB have the same virtual nickname Nickname and virtual media access control MAC address, where
the first RB is configured to negotiate with the second RB about an active/standby state, and when the state of the first RB is active, establish a neighbor relationship with another RB other than the second RB through a Hello message according to the virtual MAC address, obtain network topology information according to the virtual Nickname, and generate and deliver a neighbor check table, a reverse path forwarding RPF table, and a TRILL forwarding table; and
the second RB is configured to negotiate with the first RB about the active/standby state, and when the state of the second RB is standby, if the first RB is faulty, raise the state from standby to active, notify another RB in the network of the fault of the first RB, and generate and deliver a neighbor check table, a reverse path forwarding RPF table, and a TRILL forwarding table.

With the technical solutions provided in the embodiments of the present invention, the first RB and the second RB share the virtual Nickname and the virtual MAC address, negotiate the active/standby relationship, and construct a protection group. The active RB node, through the TRILL protocol, obtains the network topology and generates a forwarding path to perform forwarding of a data packet. When the active RB node is faulty, the state of the standby RB node is raised to be active and the data packet is forwarded through the standby RB node, so that the time for fault recovery is shortened, and the service is restored rapidly, thereby improving the performance of the TRILL network.

### BRIEF DESCRIPTION OF THE DRAWINGS

FIG. 1 is a flow chart of a method for TRILL network protection according to an embodiment of the present invention;

FIG. 2 is a block diagram of an apparatus of a router bridge RB according to an embodiment of the present invention;

FIG. 3 is a block diagram of a system for TRILL network protection according to an embodiment of the present invention.

### DETAILED DESCRIPTION OF THE EMBODIMENTS

In order to make the foregoing objectives, features, and advantages of the embodiments of the present invention more obvious and comprehensible, the embodiments of the present invention are further described in detail in the following with reference to accompanying drawings and specific implementation manners.

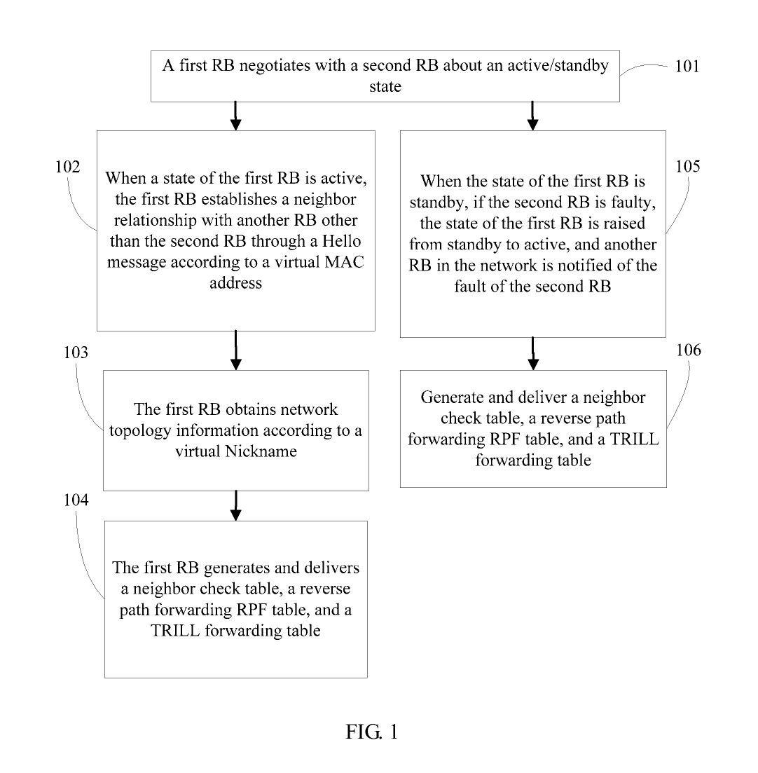

Referring to FIG. 1, it is a flow chart of a method for TRILL network protection according to an embodiment of the present invention. The method includes:

101: A first router bridge RB negotiates with a second RB about an active/standby state, where the first RB and the second RB have the same virtual nickname Nickname and virtual media access control MAC address.

Optionally, before 101, the first RB and the second RB are configured with the virtual Nickname and the virtual MAC address, for example, Nickname_Group, and MAC_Group.

Before 101, the first RB establishes a neighbor relationship with the second RB through an extended Hello message according to a MAC address of the first RB. Specifically, the first RB sends a first Hello message, where the first Hello packet includes the MAC address, for example, MAC1, of the first RB, and the virtual Nickname, and the virtual MAC address; and receives a second Hello message sent by the second RB, where the second Hello message includes a MAC address, for example, MAC2, of the second RB, and the virtual Nickname and the virtual MAC address. After multiple interactions, the neighbor relationship is established between the first RB and the second RB.

The first RB negotiates with the second RB about the active/standby state through an active-standby negotiation protocol, for example, an extended IS-IS or BPDU, where the active-standby negotiation protocol includes a priority, a virtual Nickname, and a virtual MAC address of an RB.

The first RB may carry the virtual MAC address through extending a type length value (Type Length Value, abbreviated as TLV) in the IS-IS.

The active-standby negotiation protocol may further include a MAC address of an RB.

Specifically, first, the negotiation is performed according to a priority of the first RB and a priority of the second RB, and the RB with a higher priority is active. If the priority of the first RB and that of the second RB are the same, the negotiation is then performed according to a MAC of the first RB and a MAC of the second RB, and the RB with a larger MAC address is active.

If the state of the first RB is active after the negotiation, 102 to 104 are performed. If the state of the first RB is standby after the negotiation, 105 to 106 are performed. After the negotiation, the RB in an active state is also called an active RB node, and the RB in a standby state is also called a standby RB node.

102: The first RB, namely, the active RB node, establishes a neighbor relationship with another RB other than the second RB through a Hello message according to the virtual MAC address.

The first RB, namely, the active RB node, performs a TRILL protocol interaction with another RB, while the second RB, namely, the standby RB node, does not perform any TRILL protocol interaction with another RB.

Specifically, the first RB, namely, the active RB node, sends a third Hello message, where the third Hello message includes the virtual MAC address; receives a fourth Hello message sent by another RB, where the fourth Hello message includes a MAC address of another RB; and establishes the neighbor relationship with another RB after multiple interactions.

103: The first RB, namely, the active RB node, obtains network topology information according to the virtual Nickname.

The first RB, namely, the active RB node, obtains the network topology information of a whole TRILL network through a link state packet (Link State Packet, abbreviated as LSP) of the IS-IS according to the virtual Nickname.

Optionally, the first RB, namely, the active RB node, synchronizes the network topology information to the second RB, namely, the standby RB node.

104: The first RB, namely, the active RB node, generates and delivers a neighbor check table, a reverse path forwarding RPF table, and a TRILL forwarding table.

The first RB, namely, the active RB node, calculates and generates the neighbor check table, the reverse path forwarding RPF table, and the TRILL forwarding table according to obtained network topology information.

The first RB, namely, the active RB node, delivers the neighbor check table, the reverse path forwarding RPF table, and the TRILL forwarding table, and processes and forwards a received data packet according to the tables.

The TRILL forwarding table includes a unicast forwarding table and a multicast forwarding table.

105: If the second RB is faulty, the state of the first RB, namely, the standby RB node, is raised from standby to active, and another RB in the network is notified of the fault of the second RB, namely, the active RB node.

When the state of the first RB is standby and the state of the second RB is active, the first RB, namely, the standby RB node, may detect, through an extended bidirectional forwarding detection (Bidirectional Forwarding Detection, abbreviated as BFD) message, whether the second RB, namely, the active RB node, is faulty. The first RB may also determine whether the second RB is faulty through the Hello message that maintains the neighbor relationship.

If it is detected that the second RB is faulty, the state of the first RB, namely, the standby RB node, is raised to be active, and another RB in the network is notified of the fault of the second RB. Specifically, the first RB may, based on a new type of TLV in the ISIS protocol, carry the virtual Nickname and the virtual MAC address and notify another RB in the network that the second RB, namely, the active RB node, is faulty, so that another RB in the network updates the network topology information, the neighbor check table, the reverse path forwarding RPF table, and the TRILL forwarding table. The first RB establishes a neighbor relationship with another RB through a Hello message according to the virtual MAC address, and then the first RB obtains or updates network topology information according to the virtual Nickname.

The obtaining or updating, by the first RB, namely, the standby RB node, the network topology information according to the virtual Nickname specifically is: if the first RB, namely, the standby RB node, has synchronized the network topology information from the second RB, namely, the active RB node, the first RB updates the network topology information through an LSP of the IS-IS according to the virtual Nickname; and if the first RB, namely, the standby RB node does not synchronize the network topology information from the second RB, namely, the active RB node, the first RB obtains network topology information of the whole TRILL network through an LSP of the IS-IS according to the virtual Nickname.

106: The first RB, namely, the standby RB node, generates and delivers a neighbor check table, a reverse path forwarding RPF table, and a TRILL forwarding table.

The first RB, namely, the standby RB node, generates and delivers the neighbor check table, the reverse path forwarding RPF table, and the TRILL forwarding table according to the network topology information, which ensures that a data packet can be forwarded through the first RB, and the service is restored rapidly after the second RB, namely, the active RB node is faulty, thereby improving the performance of the TRILL network.

The technical solution provided in the embodiment of the present invention not only is applied to a root node of a multicast distribution tree, but also is applied to other important nodes in the TRILL network, for example, a trunk node or a leaf node.

With the technical solution provided in the embodiment of the present invention, the active RB node and the standby RB node share the virtual Nickname and the virtual MAC address, and construct a protection group. The active RB node, through the TRILL protocol, obtains a network topology and generates a forwarding path to perform forwarding of the data packet. When the active RB node is faulty, the standby RB node is raised to be active and the data packet is forwarded through the standby RB node, so that the time for fault recovery is shortened, and the service is restored rapidly, thereby improving the performance of the TRILL network.

Referring to FIG. 2, it shows a router bridge RB according to an embodiment of the present invention. The RB includes an active/standby negotiating module 201, a neighbor establishing module 202, a topology obtaining module 203, an entry generating and delivering module 204, and a fault notifying module 205.

The active/standby negotiating module 201 is configured to negotiate with a second RB about an active/standby relationship, where the RB and the second RB have the same virtual nickname Nickname and virtual media access control MAC address.

The neighbor establishing module 202 is configured to, when the state of the RB is active, establish a neighbor relationship with another RB other than the second RB through a Hello message according to the virtual MAC address.

The topology obtaining module 203 is configured to, when the state of the RB is active, obtain network topology information according to the virtual Nickname.

The entry generating and delivering module 204 is configured to generate and deliver a neighbor check table, a reverse path forwarding RPF table, and a TRILL forwarding table.

The fault notifying module 205 is configured to, when the state of the RB is standby and the second RB is faulty, update the state of the RB to be active and notify another RB in the network of the fault of an active node. Specifically, the fault notifying module 205 may, based on a new type of TLV in an ISIS protocol, carry the virtual Nickname and the virtual MAC address and notify another RB in the network that the second RB is faulty, so that another RB in the network updates the network topology information, the neighbor check table, the reverse path forwarding RPF table, and the TRILL forwarding table.

The neighbor establishing module 202 is further configured to establish a neighbor relationship with the second RB through a Hello message according to a MAC address of the RB. Specifically, the neighbor establishing module 202 sends a first Hello message, where the first Hello message includes the MAC address of the RB, for example, MAC1; receives a second Hello message sent by the second RB, where the second Hello message includes a MAC address of the second RB, for example, MAC2; and after multiple interactions, establishes the neighbor relationship with the second RB.

The active/standby negotiating module 201 is specifically configured to negotiate with the second RB about an active/standby state through an active/standby negotiation protocol, for example, an extended IS-IS or BPDU. The active/standby negotiation protocol includes a priority, a virtual Nickname, and a virtual MAC address of an RB. The active/standby negotiating module 201 first performs negotiation according to a priority of the RB and a priority of the second RB, and the RB with a higher priority is active; and if the priority of the RB and that of the second RB are the same, further performs negotiation according to a MAC of the RB and a MAC of the second RB, and the RB with a larger MAC address is active.

The active/standby negotiation protocol may further include a MAC address of an RB.

The topology obtaining module 203 is specifically configured to, when the state of the RB is active, obtain network topology information of a whole TRILL network through an LSP of the IS-IS according to the virtual Nickname.

The RB may further include:
a topology synchronizing module, configured to, when the state of the RB is active, synchronize the network topology information to the second RB.

The RB may further include:
a fault detecting module, configured to, when the state of the RB is standby, detect whether the second RB is faulty through an extended bidirectional forwarding detection BFD message.

The entry generating and delivering module 204 is specifically configured to generate and deliver the neighbor check table, the reverse path forwarding RPF table, and the TRILL forwarding table according to the network topology information obtained by the topology obtaining module 203. The TRILL forwarding table includes a unicast forwarding table and a multicast forwarding table.

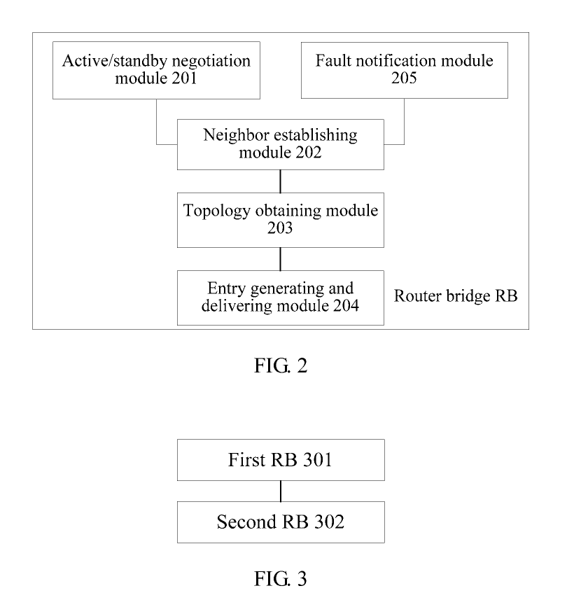

Referring to FIG. 3, it is a schematic diagram of a system for TRILL network protection according to an embodiment of the present invention. The system includes a first router bridge RB 301 and a second RB 302. The first RB 301 and the second RB 302 have the same virtual nickname Nickname and virtual media access control MAC address.

The first RB 301 is configured to negotiate with the second RB 302 about an active/standby state. When the state of the first RB 301 is active, the first RB 301 establishes a neighbor relationship with another RB other than the second RB 302 through a Hello message according to the virtual MAC address, obtains network topology information according to the virtual Nickname, and generates and delivers a neighbor check table, a reverse path forwarding RPF table, and a TRILL forwarding table.

The second RB 302 is configured to negotiate with the first RB 301 about the active/standby state, and when the state of the second RB 302 is standby, if the first RB 301 is faulty, raise the state from standby to active, notify another RB in the network of the fault of the first RB, and generate and deliver a neighbor check table, a reverse path forwarding RPF table, and a TRILL forwarding table.

Before the first RB 301 negotiates with the second RB 302 about the active/standby state, the first RB 301 and the second RB 302 are configured with the virtual Nickname and the virtual MAC address.

The first RB 301 and the second RB 302 are further configured to establish a neighbor relationship through an extended Hello message according to their respective MAC address.

The first RB 301 and the second RB 302 are specifically configured to negotiate the active/standby state through an active/standby negotiation protocol, for example, an extended IS-IS or BPDU. The active/standby negotiation protocol includes a priority, a virtual Nickname, and a virtual MAC address of an RB. First, the negotiation is performed according to a priority of the first RB 301 and a priority of the second RB 302, and the RB with a higher priority is active. If the priority of the first RB 301 and that of the second RB 302 are the same, the negotiation is then performed according to a MAC of the first RB 301 and a MAC of the second RB 302, and the RB with a larger MAC address is active.

If after the negotiation, the state of the first RB 301 is active and the state of the second RB 302 is standby, that is, the first RB is an active RB node and the second RB is a standby RB node, the first RB performs a TRILL protocol interaction with another RB, while the second RB does not perform any TRILL protocol interaction with another RB.

When the state of the first RB 301 is active, the first RB 301 is specifically configured to obtain the network topology information of the whole TRILL network through an LSP of the IS-IS according to the virtual Nickname. The first RB 301 is specifically configured to generate and deliver the neighbor check table, the reverse path forwarding RPF table, and the TRILL forwarding table according to the network topology information. The first RB 301 is further configured to process and forward a received data packet according to the neighbor check table, the reverse path forwarding RPF table, and the TRILL forwarding table. Optionally, the first RB 301 synchronizes the network topology information to the second RB 302.

When the state of the second RB 302 is standby, the second RB 302 may detect whether the first RB 301 is faulty through an extended BFD message. The second RB 302 may also determine whether the first RB 301 is faulty through a Hello message that maintains the neighbor relationship. If it is detected that the first RB 301 is faulty, the state of the second RB 302 is raised to be active, and another RB in the network is notified that the first RB 301 is faulty. Specifically, the second RB 302 may, based on a new type of TLV in an ISIS protocol, carry the virtual Nickname and the virtual MAC address and notify another RB in the network that the first RB 301 is faulty, so that another RB in the network updates the network topology information, the neighbor check table, the reverse path forwarding RPF table, and the TRILL forwarding table. The second RB 302 is further configured to establish a neighbor relationship with another RB through a Hello message according to the virtual MAC address. And then the second RB 302 obtains or updates network topology information according to the virtual Nickname, and generates and delivers a neighbor check table, a reverse path forwarding RPF table, and a TRILL forwarding table.

In this way, after the first RB 301 is faulty, a data packet may be forwarded through the second RB 302, and the service is restored rapidly, thereby improving the performance of the TRILL network.

The technical solution provided in the embodiment of the present invention not only is applied to a root node of a multicast distribution tree, but also is applied to other important nodes in the TRILL network, for example, a trunk node or a leaf node.

With the technical solution provided in the embodiments of the present invention, the active RB node and the standby RB node share the virtual Nickname and the virtual MAC address, and construct the protection group. The active RB node, through the TRILL protocol, obtains the network topology and generates the forwarding path to perform the forwarding of the data packet. When the active RB node is faulty, the standby RB node is raised to be active and the data packet is forwarded through the standby RB node, so that the time for fault recovery is shortened, thereby solving the problem that in an existing TRILL network when a root RB node is faulty, a long time for fault recovery causes a service interruption and affects network performance.

Persons of ordinary skill in the art may understand that all or a part of steps of the method of the foregoing embodiments may be implemented by a program instructing relevant hardware. The program may be stored in a computer readable storage medium, and the storage medium may be a ROM/RAM, a magnetic disk, or an optical disk and so on.

The foregoing descriptions are merely exemplary embodiments of the present invention, but the protection scope of the present invention is not limited to this. Any modification or replacement that can be easily thought of by persons skilled in the art within the technical scope disclosed in the present invention should fall within the protection scope of the present invention. Therefore, the protection scope of the present invention should be subject to the protection scope of the claims.

What is claimed is:

1. A method for Transparent Interconnection of Lots of Links TRILL network protection, comprising:
negotiating, by a first router bridge RB, with a second RB about an active/standby state, wherein the first RB and the second RB have the same virtual nickname Nickname and virtual media access control MAC address;
when the state of the first RB is active, establishing, by the first RB, a neighbor relationship with another RB other than the second RB through a Hello message according to the virtual MAC address, obtaining network topology information according to the virtual Nickname, and generating and delivering a neighbor check table, a reverse path forwarding RPF table, and a TRILL forwarding table; and
when the state of the first RB is standby, if the second RB is faulty, raising the state of the first RB from standby to active, and notifying another RB in the network of the fault of the second RB so that another RB updates the network topology information, the neighbor check table, the reverse path forwarding RPF table, and the TRILL forwarding table, and generating and delivering, by the first RB, a neighbor check table, a reverse path forwarding RPF table, and a TRILL forwarding table.

2. The method according to claim 1, wherein the negotiating, by the first RB, with the second RB about the active/standby state specifically comprises:
negotiating, by the first RB, with the second RB about the active/standby state through an active/standby negotiation protocol, wherein the active/standby negotiation protocol comprises a priority, a virtual Nickname, and a virtual MAC address of an RB.

3. The method according to claim 2, wherein before the negotiating, by the first RB, with the second RB about the active/standby state, the method further comprises:
establishing, by the first RB, a neighbor relationship with the second RB through a Hello message according to a MAC address of the first RB.

4. The method according to claim 3, further comprising:
when the state of the first RB is active, synchronizing, by the first RB, the network topology information to the second RB so that the second RB generates a neighbor check table, a reverse path forwarding RPF table, and a TRILL forwarding table according to the network topology information;
when the state of the first RB is standby, detecting, by the first RB, whether the second RB is faulty through an extended bidirectional forwarding detection BFD message.

5. The method according to claim 2, further comprising:
when the state of the first RB is active, synchronizing, by the first RB, the network topology information to the second RB so that the second RB generates a neighbor check table, a reverse path forwarding RPF table, and a TRILL forwarding table according to the network topology information;
when the state of the first RB is standby, detecting, by the first RB, whether the second RB is faulty through an extended bidirectional forwarding detection BFD message.

6. The method according to claim 1, wherein before the negotiating, by the first RB, with the second RB about the active/standby state, the method further comprises:
establishing, by the first RB, a neighbor relationship with the second RB through a Hello message according to a MAC address of the first RB.

7. The method according to claim 6, further comprising:
when the state of the first RB is active, synchronizing, by the first RB, the network topology information to the second RB so that the second RB generates a neighbor check table, a reverse path forwarding RPF table, and a TRILL forwarding table according to the network topology information;
when the state of the first RB is standby, detecting, by the first RB, whether the second RB is faulty through an extended bidirectional forwarding detection BFD message.

8. The method according to claim 1, further comprising:
when the state of the first RB is active, synchronizing, by the first RB, the network topology information to the second RB so that the second RB generates a neighbor check table, a reverse path forwarding RPF table, and a TRILL forwarding table according to the network topology information.

9. The method according to claim 1, further comprising:
when the state of the first RB is standby, detecting, by the first RB, whether the second RB is faulty through an extended bidirectional forwarding detection BFD message.

10. A router bridge RB, wherein the RB comprises an active/standby negotiating module, a neighbor establishing module, a topology obtaining module, an entry generating and delivering module, and a fault notifying module, wherein
the active/standby negotiating module is configured to negotiate with a second RB about an active/standby relationship, wherein the RB and the second RB have the same virtual nickname Nickname and virtual media access control MAC address;
the neighbor establishing module is configured to, when the state of the RB is active, establish a neighbor relationship with another RB other than the second RB through a Hello message according to the virtual MAC address;
the topology obtaining module is configured to, when the state of the RB is active, obtain network topology information according to the virtual Nickname;
the entry generating and delivering module is configured to generate and deliver a neighbor check table, a reverse path forwarding RPF table, and a TRILL forwarding table; and
the fault notifying module is configured to, when the state of the RB is standby and the second RB is faulty, update the state of the RB to be active and notify another RB in the network of the fault of an active node.

11. The RB according to claim 10, wherein the active/standby negotiating module is specifically configured to negotiate with the second RB about the active/standby state through an active/standby negotiation protocol, wherein the active/standby negotiation protocol comprises a priority, a virtual Nickname, and a virtual MAC address of an RB.

12. The RB according to claim 11, wherein the neighbor establishing module is further configured to establish a neighbor relationship with the second RB through a Hello message according to a MAC address of the RB.

13. The RB according to claim 12, further comprising:
a topology synchronizing module, configured to, when the state of the RB is active, synchronize the network topology information to the second RB.

14. The RB according to claim 11, further comprising:
a topology synchronizing module, configured to, when the state of the RB is active, synchronize the network topology information to the second RB.

15. The RB according to claim 10, wherein the neighbor establishing module is further configured to establish a neighbor relationship with the second RB through a Hello message according to a MAC address of the RB.

16. The RB according to claim 15, further comprising:
a topology synchronizing module, configured to, when the state of the RB is active, synchronize the network topology information to the second RB.

17. The RB according to claim 10, further comprising:
a topology synchronizing module, configured to, when the state of the RB is active, synchronize the network topology information to the second RB.

18. A system for Transparent Interconnection of Lots of Links TRILL network protection, wherein the system comprises a first router bridge RB and a second RB, and the first RB and the second RB have the same virtual nickname Nickname and virtual media access control MAC address, wherein
the first RB is configured to negotiate with the second RB about an active/standby state, and when the state of the first RB is active, establish a neighbor relationship with another RB other than the second RB through a Hello message according to the virtual MAC address, obtain network topology information according to the virtual Nickname, and generate and deliver a neighbor check table, a reverse path forwarding RPF table, and a TRILL forwarding table; and
the second RB is configured to negotiate with the first RB about the active/standby state, and when the state of the second RB is standby, if the first RB is faulty, raise the state from standby to active, notify another RB in the network of the fault of the first RB, and generate and deliver a neighbor check table, a reverse path forwarding RPF table, and a TRILL forwarding table.
